(19) United States
(12) Patent Application Publication
(10) Pub. No.: US 2006/0244412 A1
(43) Pub. Date: Nov. 2, 2006

(54) Automotive jump-starter with polarity detection, current routing circuitry and lighted cable connection pairs

(75) Inventors: Robert Bonzer, Boise, ID (US); Greg Howard, Boise, ID (US)

Correspondence Address: DEREK H. MAUGHAN;DYKAS, SHAVER & NIPPER, LLP, PO BOX 877, BOISE, ID, 83701-0877, US

(73) Assignee: Bon-Aire Industries, Inc., Boise, ID (US)

(21) Appl. No.: 11/120,834

(22) Filed: May 2, 2005

(51) Int. Cl. H02J 7/00

(52) U.S. Cl. 320/105

(57) ABSTRACT

A battery charger for use on lead acid and dry cell batteries having a polarity detection mechanism, automated current routing circuitry and connected adaptive illumination. The battery charger of the present invention includes an internal battery, an external battery, a solenoid-type switching device and a control circuit. When connected and activated, input from the battery to be jump-started is routed through a control circuit so as to function in conjunction with the internal battery to activate one of a pair of solenoids so as to provide a proper pathway that ensures the configured to provide safe, spark free jump-starting, as well as convenient illumination to the user.

### BACKGROUND OF THE INVENTION

1. Field of the Invention

The present invention generally relates to mechanisms for charging automotive batteries, and more particularly to self-contained jump-starting apparatuses that contain a power source and a pair of cables that can be utilized to connect with and provide power to a disabled battery. The purpose of the connection with the disabled battery is in most instances to provide sufficient additional power so as to enable an automobile ignition system to operate.

2. Background Information

Lead acid and dry cell batteries are used in almost everything today, including motorcycles, ATVs, motor homes, automobiles, etc. One of the problems that exist with these batteries is that over time these batteries expend the power that is stored within them and as a result prove to be ineffective in providing sufficient power so as to enable a party to start a device such as an automobile. When such an instance occurs a party may “jump start” the vehicle by providing power from another source to the “low battery”.

Providing a source of direct current to the battery that is to be charged typically charges these batteries and provides sufficient power to allow the device to operate. A variety of different types of devices for providing this increased source of material to the battery exist. These include devices such as jumper cables. Jumper cables are typically comprised of two sets of cables. One set of cables is configured to connect the positive terminal of a first battery to the positive terminal of a second battery. The first battery is charged and the second battery is typically charge deficient. The second set of cables extends from the negative terminal of the first battery to an electrical ground such as the metal frame of the automobile or the engine block.

When connected properly a circuit is completed and power is able to flow from the powered battery to the battery to be powered. In addition to jumper cables, a variety of other types of devices also exist which utilize a similar type of configuration to allow a depleted battery to be re-energized.

These prior art devices, however, are also subject to a variety of deficiencies. One of the greatest deficiencies relates to the possibly dangerous consequences that may arise through improper use of such a device. When someone tries to charge a discharged battery, they must know which cable should be connected to which terminal on the battery and the order in which the cables should be connected. If the cables are connected in an improper order, the device may short circuit. This short-circuiting may cause extremely large current flows, arcing or sparking, dangerous over-heating of the cables and battery damage to the battery or supply, and possibly even explosion. When the discharged battery is within another larger device such as an automobile, truck, plane or other vehicle, damage to the electrical apparatus of that vehicle may also occur. This damage can occur not only to the disabled battery and the vehicle in which it is contained, but also to the powered battery and the vehicle in which it is contained.

The problem associated with properly connecting a battery is further exacerbated when the determination of the polarity of the batteries is difficult. Such a situation occurs when the markers indicating the polarity of the battery are obscured by dirt and oil, when the lighting conditions are poor (such as at night), or when the weather conditions are adverse (such as rain, snow or cold). These circumstances increase the probability that an error could be made in attempting to jump-start the disabled vehicle. As discussed previously, such an error could have disastrous consequences.

Therefore what is needed is a device that can be used simply and easily to provide power to a disabled battery. What is also needed is a device that enables a user to safely and accurately provide power to a disabled battery without regard to the alignment or orientation of the cables. What is also needed is a portable jump-starting device that can be utilized safely and easily in a variety of weather conditions by a person of limited skill or experience.

Accordingly, it is an object of the present invention to provide a device that can be used to simply and easily provide power to a disabled battery. It is a further object of the invention to provide a device that enables a user to safely and accurately provide power to a disabled battery without regard to the alignment or orientation of the cables. It is a further object of the invention to provide a portable jump-starting device that can be utilized in a variety of weather conditions by a person of limited skill or experience. Another object of the invention is to provide a jump-starting device that appropriately routes electricity to the discharged battery and stops the flow of electricity through the device when a desired charge level has been reached.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In the preferred embodiment of the invention, the invention is a self-contained jump-starter having an internal battery that can be utilized to charge a discharged battery. The self-contained jump-starter principally contains an internal charge source battery that is housed within a housing. This internal battery is connected through a switching system to a pair of external cables, which are configured to connect with the terminal portions of a battery that is to be jump-started. In the preferred embodiment, a light source, preferably a light emitting diode is attached to the ends of the battery cable and is configured to draw current from the internal battery so as to provide sufficient illumination so as to allow a user to locate and properly find the terminals upon which the device can be connected.

Regardless of whether or not the ends of the device have been attached to the proper terminals of the battery, the present invention ensures that the connection between the internal battery of the jump-starter and the proper terminals on the battery to be charged are properly aligned so as to allow the proper flow of electricity from the charged internal battery to the battery to be jump-started.

In the preferred embodiment, this switching is performed through the use of a pair of solenoids which are operatively connected to a single rod. This rod is then connected to a pair of plates and placed within a box. This box contains four electrically conducting connections, each of these electrically conducting connections attached to a cable. In use, each of these cables is connected to a terminal of either the internal battery within the jump-starter or a cable connection that is connected to a battery that needs to be charged through a pair of clamps. Each of these solenoids is also connected to a sensing and control circuit. This sensing and control circuit is configured to receive inputs from the terminals of the battery to be charged and to activate the appropriate solenoid switch so as to align the flow of charge between the positive terminal of the charging battery to the positive terminal of the battery to be charged. This feature also assists to ensure that the proper connection between the batteries exists and significantly reduces the chance of explosion or damage to the batteries as a result of improperly connecting the battery terminals.

The purpose of the foregoing Abstract is to enable the United States Patent and Trademark Office and the public generally, and especially the scientists, engineers,-and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective front plan view of a preferred first embodiment of the invention.

FIG. 2 is a view of the solenoid connection portions of the present invention.

FIG. 3 is a schematic of the wiring schematic of the first preferred embodiment of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

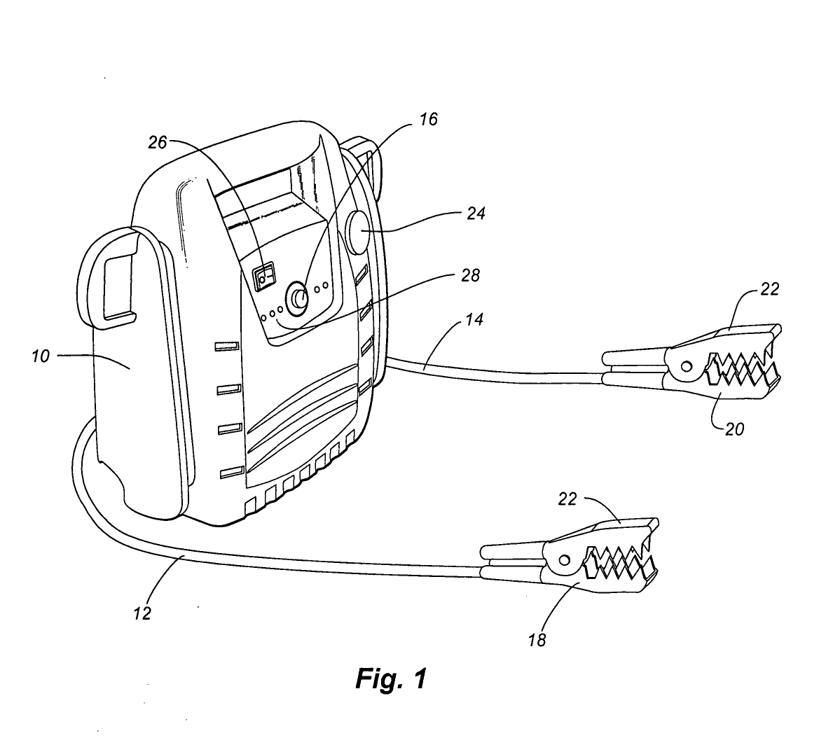

FIGS. 1-3 of the present invention show various features of the preferred embodiment of the invention. In its simplest form, the present invention is a self-contained jump-starter unit that can be utilized by persons with little or no skill or experience in the field of automotive repair. In the simplest form, the invention is comprised of an internal battery 40 having positive and negative terminals. This internal battery 40 is electrically and operatively connected to a control circuit 70 and to a solenoid switching device 80. This control circuit 70 and the solenoid switching device 80 are also operatively connected to a pair of cables 12, 14 which are equipped with clamps 18, 20 at the end of these cables 12, 14. The internal battery 40, control circuit 70 and the solenoid switching mechanism 80 are typically contained within a housing 10.

In use the clamps 18, 20 are placed and positioned upon the terminals of an external battery or a battery that is to be jump-started. Once this has been accomplished, the device can be activated through the use of a switch 16 which is typically located on the face portion of the housing. When the device is activated, electrical charge is transmitted from the external battery through the cables 18, 20 to the solenoid switching device 80 and the control circuit 70. Upon activation by the switch 16, the control circuit 70 connecting the external battery to the internal battery is completed. Upon this completion the control circuit 70 channels the input charge from the external battery so as to activate one of two solenoids in the solenoid switching device 70. This activated solenoid is then activated to close a transfer connection which allows the positive charge from the positive terminal of the internal battery 40 to be transferred to the positive terminal of the external battery regardless of how the clamps 18, 20 are positioned. This capability provides a significant advantage over the other features and devices that exist in the prior art.

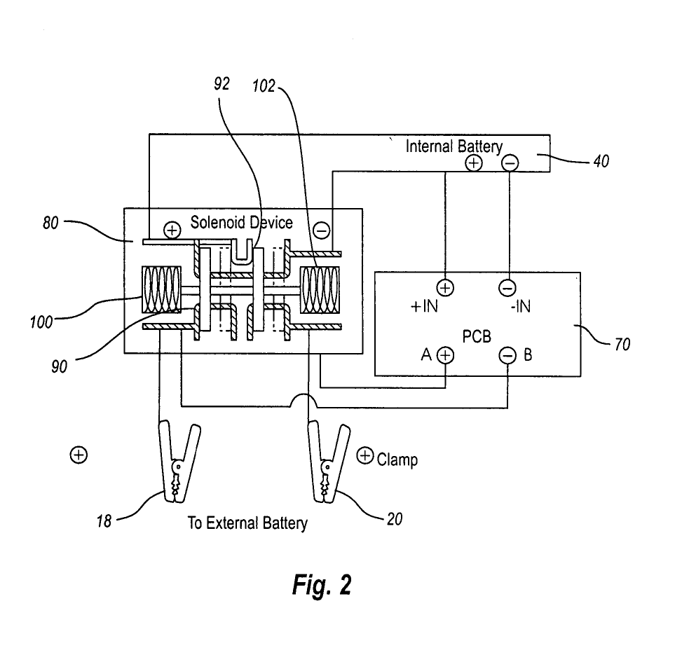

Referring first to FIG. 1, a perspective view of the front plan view of the present invention is shown. The present invention is a jump-starter that comprises a housing 10 having a pair of cables 12, 14 that extend therefrom. The housing 10 contains an internal battery 40, (shown in FIG. 2) which is adapted to provide a sufficient amount of current to another battery that is depleted or to be jump-started. Preferably, the battery within the housing 10 is a rechargeable battery that is provided with appropriate accompanying circuitry so as to allow the battery to be recharged from a standard alternating current power supply. The internal battery is connected to a pair of cables 12, 14 through a switching system which will be discussed further hereafter. These cables 12, 14 are connected to clamps 18, 20 which are each equipped with a light 22 that can be activated so as to facilitate a user in finding the location of the terminal upon which the clamps 18, 20 are to be attached.

In the preferred embodiment, these lights 22 are LED lights, however it is to be distinctly understood that the invention is not limited thereto but may be variously embodied to meet the necessities of the user. In the preferred embodiment an accessory voltage access port 24 is also present so as to allow the battery of the device to be utilized to power a variety of other types of devices.

In one embodiment of the invention the housing portion 10 of the device contains a switch 16 to send power through the cables of the device, a switch 26 to activate the lights that are attached to the ends of the clamps 18, 20 and several indicator lights 28 which signal such things as the status of the battery being charged, the battery from which the charge is being processed and the activation status of the cable clamps.

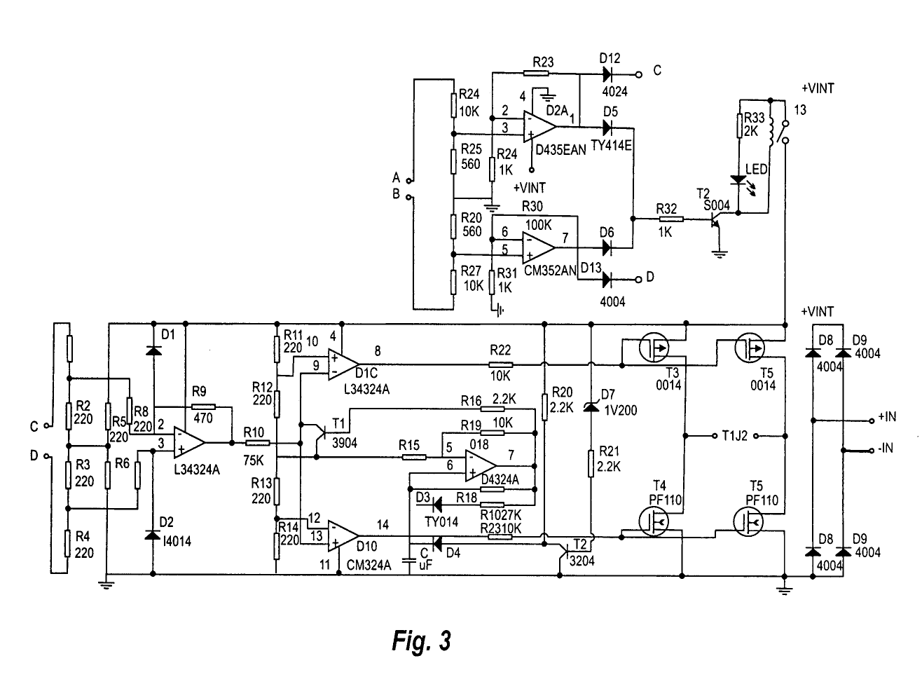

FIGS. 2 and 3 show the internal battery connection device and show various routing schematics of the internal component parts of the present invention.

FIG. 2 shows the connection of the internal battery 40 to the cable clamps 18, 20 which in use are placed upon the external battery or the battery that is to be jumped. The control circuit 70 described hereafter in the preferred embodiment is connected to and printed upon a printed circuit board. This circuit 70 is connected to a solenoid switching device 80 which appropriately directs the flow of electricity from the internal battery 40 to the appropriate terminals of the external battery. In one embodiment, the negative terminal of the internal battery is connected to one side (D) of the solenoid device 80 as well as to the negative input portion on the control circuit 70. The positive terminal of the internal battery 40 is connected to the other side (C) of the solenoid device 80, as well as to the positive input side of the control circuit 70. The portions (A) and (B) of the solenoid device are connected to the clamps which are configured to connect with the external battery which is the battery that is to be jump-started, as well as the control circuit.

When the cable clamps 18, 20 are connected to the battery terminals of the battery to be activated; the charge of these battery terminals is input into the control circuit 70. As is shown and described in FIG. 3, the circuit then activates one of two solenoids 100, 102. These solenoids then push a pair of plates 90, 92 into one of two configurations. In the first configuration, the plates 90, 92 are pushed by the solenoids 100, 102 so as to connect cable 20 with the positive terminal of the internal battery. In the second configuration, the solenoids are activated so as to push the plates 90, 92 in such a way so as to connect cable 18 to the positive terminal of the internal battery.

The determination as to which solenoid operates to push the plates and connect the positive terminal of the internal battery with the positive terminal of the external battery is provided through the control circuit shown in FIG. 3.

FIG. 3 shows the schematic of the control circuit 70, which selectively ensures that positive charge will be transmitted from the internal battery to the positive terminal on the battery to be charged. FIG. 3 shows the preferred way of aligning and directing the charge from the external battery to the internal battery with a directed charge. While this specific pathway for performing this function is shown, it is to be distinctly understood that the invention is not limited thereto but may be variously configured according to the needs of a user.

In the preferred embodiment, the device of the present invention is utilized as follows: The terminals of the battery to be charged are connected to the clamps 18, 20 which are connected to the solenoid switching box 70 through the cables 12 and 14. At the solenoid box a wire from each of these cables 18, 20 and having the same charge as these cables 18, 20 is connected to the control circuit (shown in FIG. 3), these inputs from the clamps are designated as A and B in the control circuit diagram (shown in FIG. 3).

At the connection of these cables additional wires extend from the connection with the plates 90, 92 within the solenoid device 80 to connect with the control circuit of the present invention. In addition, internal connection cables from the internal battery 40 to the control circuit 70 are also connected. Once the circuit is completed by the operation of manually connecting the switch 16 to close the circuit 70, electrical current from the external battery is routed through a series of resistors, amplifiers and diodes so as to close the connection between one of the two solenoids 100, 102 which are located within the solenoid switching device. When this connection has been created the devices function together to initiate and energize the solenoids 100,102 so as to move the plates 90, 92 and create a pathway for charge to flow from the internal battery 40 to the battery on the device that is to be charged. The preferred embodiment of this circuit is shown in the attached FIG. 3.

This protective circuit ensures that a charge from the positive terminal of the internal battery is connected with the positive terminal of the external battery that is to be jump-started. This prevents the charge from the internal battery from traveling improperly connecting with the battery to be charged, and prevents the dangers that are associated with this occurrence. The present invention allows a party to safely jump start a car with a battery by simply connecting the two cables on the device with the two terminals on the car battery activating the device and starting the car. The internal circuitry of the present invention detects and channels the flow of power from the storage battery to the battery to be charged. The present invention also prevents arcing or overheating of the cables or the battery itself and appropriately shuts off so as to prevent over-heating of the internal charge battery or damage to the battery that is to be charged. The result is a device that is easy, safe and effective to use.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An automobile jump-starter configured to properly connect an internal battery having a positive terminal and a negative terminal located with an external battery having a positive terminal and a negative terminal said automobile jump starter comprising:
a housing;
an internal battery located within said housing; said internal battery having a positive terminal and a negative terminal;
a solenoid switching device electrically connected to said internal battery;
a pair of cables extending from said solenoid device to a pair of clamps, each of said clamps having a lighting device connected thereto said clamps configured to connect with the positive and negative terminals of an external battery;
a control circuit electrically connected to said solenoid device and to said internal battery, said control circuit comprising a first switch for illuminating said clamps and a second switch for transmitting power from said internal battery to said external battery through said solenoid switching device, said control circuit configured to sense the polarity of the terminals of the external battery through the cables and to direct the flow of charge from the positive terminal of the internal battery to the positive terminal of the external battery through the cables.

2. The automobile jump-starter of claim 1 wherein said lighting devices are powered by said internal battery.

3. The automobile jump-starter of claim 1 wherein said illumination devices are light emitting diodes.

4. The automobile jump-starter of claim 1 wherein said control circuit contains an indicator light said indicator light configured to demonstrate and show when the said internal battery is activated.

5. The automobile jump-starter of claim 1 wherein said solenoid switching device contains a pair of plates connected to a plunger, said plunger moveable between a first position and a second position, said plates configured to interact with cable connection devices located within said solenoid switching device.

6. The automobile jump-starter of claim 1 wherein said control circuit comprises an electrical pathway configured to activate said solenoid switching device so as to channel electrical current.

7. The automobile jump-starter of claim 6 wherein said control circuit comprises a light emitting diode.

8. The automobile jump-starter of claim 7 wherein said control circuit comprises at least one capacitor.

9. The automobile jump-starter of claim 8 wherein said control circuit comprises diodes positioned along said pathway.

10. The automobile jump-starter of claim 9 wherein said control circuit comprises at least four differential amplifiers.

11. A self contained automobile jump starter comprising:
an attaching device configured to attach said jump-starter to a vehicle to be jump-started;
a power providing device configured to provide a designated amount of electrical power through said attaching device; and
a charge directing device configured to determine the polarity of the terminals of the battery to be jump-started and to direct current of the proper polarity to said terminal.
